(19) United States
(12) Patent Application Publication
(10) Pub. No.: US 2003/0217685 A1
(43) Pub. Date: Nov. 27, 2003

(54) Flag printing method

(76) Inventor: James E. Aldridge, Sanford, NC (US)

Correspondence Address: WILLIAM J. MASON, MACCORD MASON PLLC, POST OFFICE BOX 1489, WRIGHTSVILLE BEACH, NC, 28480, US

(21) Appl. No.: 10/437,352

(22) Filed: May 13, 2003

Related U.S. Application Data
(60) Provisional application No. 60/383,320, filed on May 24, 2002.

(51) Int. Cl. G09F 17/00

(52) U.S. Cl. 116/173

(57) ABSTRACT

Flags with at least one printed side, hemmed side edges, and a first end edge including a flagpole sleeve are made from a continuous sheet of textile material by cutting flag-length sections from the sheet, each section having hemmed side edges and at least one printed side, and forming a flagpole sleeve along the first end edge of the flag section. Formation of the flagpole sleeve after the flag section is printed, as opposed to printing after formation of the flagpole sleeve as in the prior art, results in improved production speeds and improved products. The sleeve may be formed by folding over the first end edge, or by separately attaching a loop of textile material.

This application claims the benefit of the filing date of provisional application Serial No. 60,383,320, filed May 24, 2002.

### BACKGROUND OF THE INVENTION

(1) Field of the Invention

The present invention relates generally to a method for printing flags by transfer or sublimation printing, and in particular to a method for decreasing printing time, and thereby reducing the cost of manufacture, while increasing product quality.

(2) Description of the Prior Art

The present invention relates to the manufacture of flags, such as the United States flag or decorative flags that are comprised of a sheet of textile material having a loop or sleeve of material along one edge for insertion of a flagpole, with the sheet being hemmed along the remaining edges. The sheet is normally rectangular, but may also be of other shapes, such as triangular. One or both sides of the sheet are normally printed with an appropriate indicia, such as the stars and stripes for the United States flag, or various symbols, logos or designs of the type seen on decorative flags.

It is the current practice to manufacture complete blank flags by hemming the edges of the fabric used to form the flag. One end edge of the flag is then folded over and sewn to the flag surface to form a sleeve for insertion of the flagpole. If desired, tabs can also be inserted and attached adjacent the ends of the sleeve so that screws or other attachment means can be inserted through the tabs and into the flagpole to secure the flag to the pole. Alternatively, a separate sleeve can be sewn to one end of the flag. The completed blank flag is then shipped from the flag manufacturer to a printer, who prints indicia on one or both sides of the flag by the method previously described.

Since the quantity of flags produced on a given run is limited, and the need for a quality, durable image is high, the indicia are often printed by dye transfer printing, or dye sublimation printing. In dye sublimation printing, a mirror image of the design is first printed onto a paper substrate with sublimation dyes. The printed substrate is then placed against the fabric, which contains at least 50% polyester fiber, and preferably 100% polyester fiber. The substrate and fabric are then heated under temperature and pressure conditions sufficient to cause the dye to sublime to a gas that penetrates the fabric and then bonding as a solid into the polyester fibers. As a result, a permanent, highly detailed design is formed on the fabric surface.

When printing on both sides of the fabric is desired, two indicia, one for each fabric side, are printed on the substrate. The printed substrate is then folded over an edge of the fabric, with the indicia being aligned with each other on opposite sides of the fabric. In commercial operations, the flags with the folded substrate are fed through a flatbed printer or a drum roller that subjects the substrate and fabric to the required temperature and pressure.

Printing of flags tends to be quite slow, increasing the cost of the finished product. For example, when flags having indicia with dark colors are being printed, the feed rate of flags of a dimension of about 24×36 in. through the printer is normally on the order of 1 to 1.5 yards/minute. Lighter colors can be fed at a slightly higher rate of about 2 to 5 yards/minute. There is a continuing need for a method that would significantly increase flag production costs, without sacrificing product quality.

### SUMMARY OF THE INVENTION

In accordance with the present invention, it has been determined that this processing speed can be approximately doubled, resulting in a significant reduction in processing cost, by modifying the procedure by which the flags are sewn and printed. Surprisingly, it has also been found that the method described herein reduces second quality products and misprints, thereby resulting in more first quality products.

Specifically, it has been determined that the processing speed can be increased by delaying formation of the pole sleeve until after hemming and printing. By this procedure, the double hem thickness formed where the sleeve is folded over during sleeve formation is not present during printing. Without this extra hem thickness, it has been discovered that the feed rate can be significantly increased without any diminution in the quality of the indicia being printed.

Thus, a preferred method of the present invention comprises the steps of 1) providing a roll of woven polyester fabric, e.g., 600 yds, of a desired width; 2) hemming both sides of fabric; 3) cutting the fabric to desired flag-lengths, e.g. 37 or 42 in.; 4) printing both sides of the fabric by sublimation dye printing as previously described; and 5) thereafter forming the pole sleeve or pocket along one end edge of the printed fabric. The pole sleeve may be formed by either folding over one end of the fabric and sewing the edge to the fabric surface to form the sleeve, or by sewing a separate sleeve onto the edge of the fabric. Instead of a woven fabric, the method can also be applied to nonwoven fabrics, knitted fabrics, and other textile materials.

Alternatively, a roll of fabric having the desired width can be fed continuously through the printer with sublimation dye substrates being folded over successive sections of the fabric as the fabric is fed. The substrate can also be printed on a continuous roll that is fed with the fabric. When printing on both sides of the fabric, one substrate roll is fed on either side of the fabric. After printing, the fabric is cut to the desired lengths, and the edges are hemmed. The sleeve is then formed or attached along one of the edges to complete the flag.

### BRIEF DESCRIPTION OF THE DRAWINGS

FIG. 1 is a side view of a finished, printed prior art flag.

FIG. 2 is a side view of a sheet of prior art textile material with side edges seamed.

FIG. 3 is a side view of a completely sewn prior art flag prior to printing.

FIG. 4 is a side view of a completely sewn prior art flag with a substrate carrying the printing dye folded over one edge of the flag in preparation for printing on both sides of the flag.

FIG. 5 is a sectional end view of the prior art flag and substrate of FIG. 4.

FIG. 6 is a side view of a continuous textile sheet with sewn side edges.

FIG. 7 is a cut and hemmed flag-length sheet section with a folded printing substrate.

FIG. 8 is a side view of a hemmed, printed flag-length sheet section and a flag pole sleeve prior to attachment to form the finished flag.

FIG. 9 is a side view of a finished flag formed by the preferred method.

FIG. 10 is a side view of a continuous strip of sheet material with a plurality of adjacent folded substrates carrying printed indicia.

FIG. 11 is a side view of a flag-length section of the sheet of FIG. 10 after printing and cutting.

FIG. 12 is a side view of a flag-length section of the sheet of FIG. 10 after printing, cutting and side hemming.

FIG. 13 is a side view of a finished flag formed by the alternative method.

FIG. 14 is a continuous, hemmed sheet with a plurality of adjacent substrates carrying printed indicia.

FIG. 15 is a continuous, hemmed sheet with a plurality of adjacent printed indicia.

### DETAILED DESCRIPTION OF THE INVENTION

In the following description, terms such as horizontal, upright, vertical, above, below, beneath, and the like, are used solely for the purpose of clarity in illustrating the invention, and should not be taken as words of limitation. The drawings are for the purpose of illustrating the invention and are not intended to be to scale.

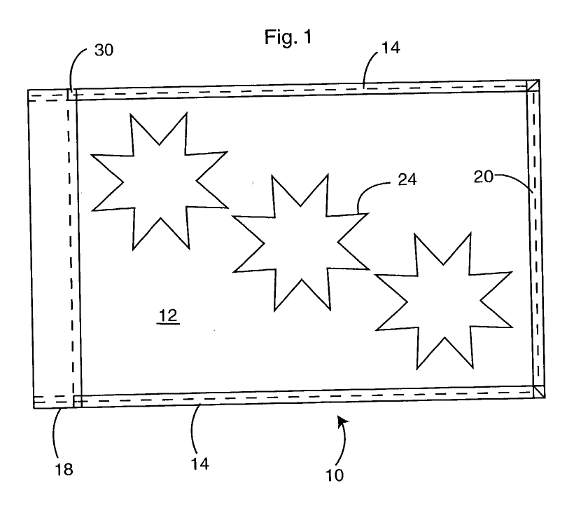

FIG. 1 illustrates a typical printed flag 10, not intended to be to scale. Flag 10 is comprised of a woven polyester fabric flag-length sheet section 12 with hems 14 along its side edges. The term “flag-length” means a length of fabric having the dimensions of the finished flag, plus any fabric required for hemming and sleeve formation. A flagpole sleeve 18 is formed at one end of sheet section 12, either by folding the end of sheet section 12 onto itself, or by separately attaching a loop of textile material. The opposed end 20 is hemmed. Finally, representative indicia 24 are printed onto one or both sides of sheet 12 by sublimation printing.

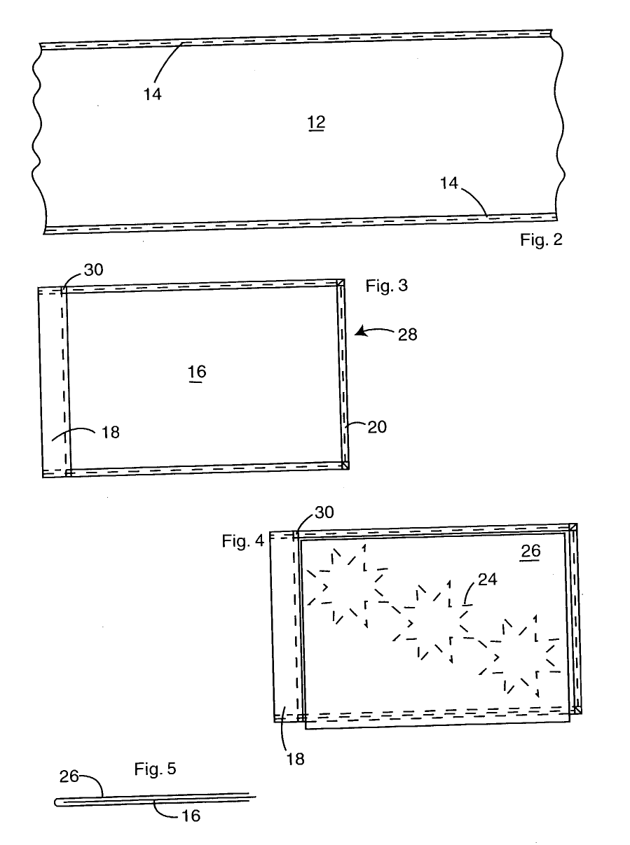

FIGS. 2-5 illustrate formation of a flag as illustrated in FIG. 1 by the prior art method. Specifically, a continuous textile sheet 12 is hemmed along its parallel side edges 14, as illustrated in FIG. 2. Side hemmed sheet 12 is the cut into flag-length sections 16. A flagpole sleeve 18 is formed at one end of the sheet section 16, e.g., by folding over the end of sheet section 16 and hemming it to itself, or by separately attaching a loop of material. The opposite edge 20 of sheet section 16 is also hemmed, resulting in a flag 24, ready for printing. A substrate 26, normally of paper, with indicia 24 printed at two locations is then folded over a side edge of flag 16, so that the two printed locations are in registry on opposite sides of flag 16. Substrate 26 and flag 16 are then placed under pressure at a high temperature to transfer indicia 28 to flag 16. Thus, in the prior art method, indicia 28 are printed after sleeve 18 is formed. Since flag 16 is formed prior to printing, double-fold sections 30 exist when flag 16 is printed. A flag having the configuration shown in FIG. 1 is thus produced.

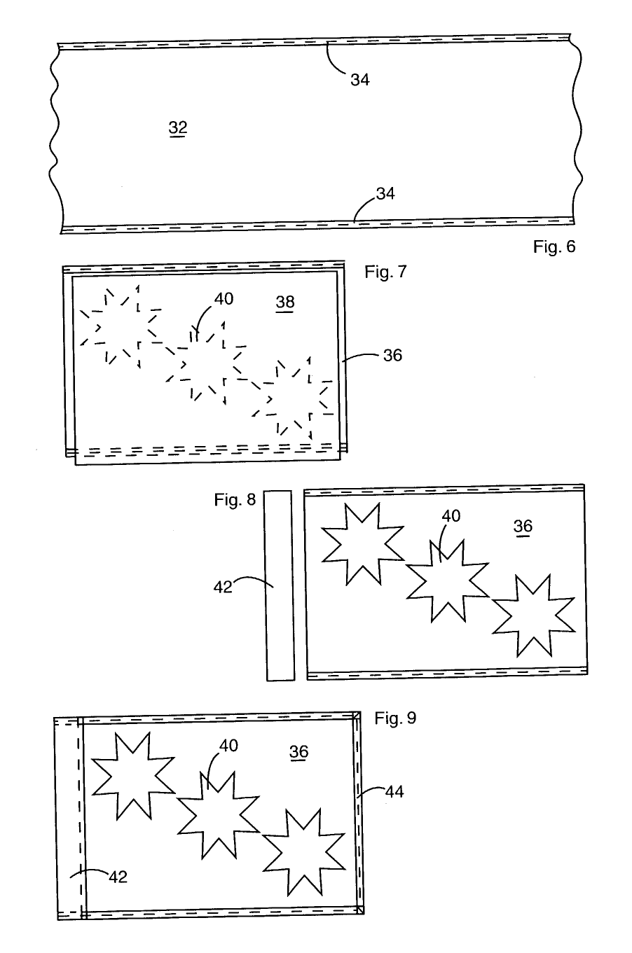

In a first embodiment of the present method, as illustrated in FIGS. 6-9, a continuous sheet of textile material 32, illustrated in FIG. 6 and equivalent to the textile sheet 12 illustrated in FIG. 2, is hemmed along its opposed sides 34. Hemmed sheet 32 is cut into flag-length sheet sections 36 as shown in FIG. 7. Printed substrate 38 with indicia 40 printed at two locations, is then folded over a side edge of sheet section 36, so that the two printed locations are in registry on opposite sides of the sheet section 36. Sheet section 36 and substrate 38 is then placed under pressure at a high temperature to transfer the indicia to sheet section 36. Flagpole sleeve 42 is separately attached at one end of section 36, and the opposed end 44 is hemmed to form a flag having the configuration of the flag shown in FIG. 9, which is similar to FIG. 1. It will be understood that sleeve 42 can also be formed by folding over the end of section 36.

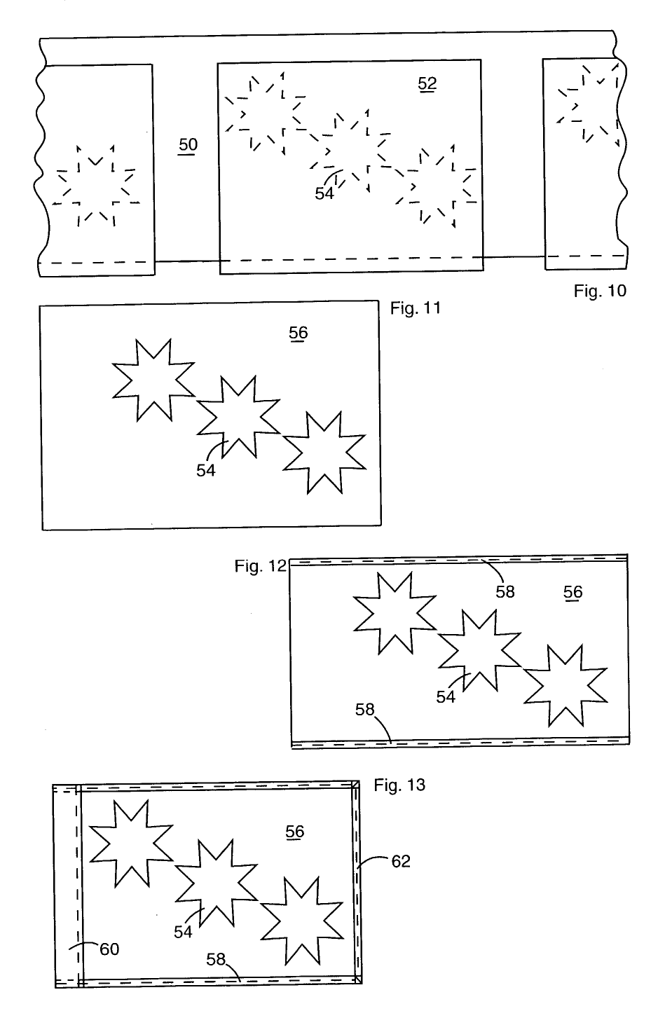

In another embodiment of the invention illustrated in FIGS. 10-13, unhemmed textile sheet 50 and a plurality of printed substrates 52 with indicia 54 printed at two locations, folded adjacent each other over a side edge of sheet 50, are placed under pressure at a high temperature to transfer indicia 54 to sheet 50. After printing, sheet 50 is cut into flag-length sheet sections 56 as shown in FIG. 10, and then hemmed along side edges 58 as shown in FIG. 12. A flagpole sleeve 60 is then formed at one end of section 56, separately or by folding over the end of section 56, and the opposed edge 62 is hemmed to form a flag having the configuration of the flag shown in FIG. 13. Thus, by this method, or by the first embodiment of the invention, the double hem thickness 30 illustrated in FIG. 1, is not present during printing, thereby permitting a significant increase in printing speed with resultant cost savings, as well as an improvement in product quality.

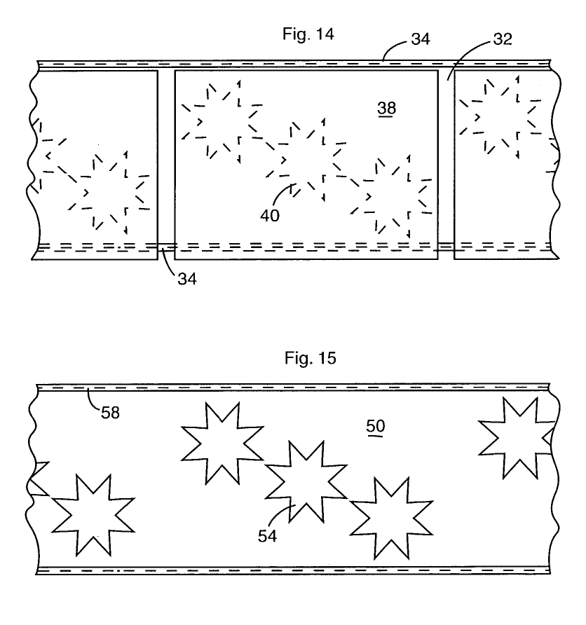

In still another embodiment of the invention, hemmed sheet 32 of FIG. 6 is first printed as illustrated in FIG. 14, and then cut into flag-length sections like FIG. 7. In yet another embodiment of the invention, unhemmed sheet 50 of FIG. 10 is hemmed as shown in FIG. 15 and then cut into flag-length sections shown in FIG. 12. Alternatively, unhemmed sheet 50 of FIG. 10 can be cut into flag-length sections prior to hemming of the edges and printing. In all embodiments, the flag is side hemmed and printed prior to formation of the flag sleeve, thereby increasing production speed and quality.

While the invention is described with specific reference to the printing of flags, it will be understood that the invention also finds utility in the printing of banners and other printed and hemmed textile products. Also, certain modifications and improvements will occur to those skilled in the art upon a reading of the foregoing description. It should be understood that all such modifications and improvements are properly within the scope of the invention.

What is claimed is:

1. A method of making a flag with at least one printed side, hemmed side edges, and a first end edge including a flagpole sleeve comprising:
a) providing a flag-length section of a textile sheet, said section having a first end edge, hemmed side edges and at least one printed side; and
c) forming a flagpole sleeve along said first end edge of said section, said sleeve being formed after said section is printed.

2. The method of claim 1, wherein the side edges of said flag-length section are hemmed prior to printing.

3. The method of claim 1, wherein said flag-length section is printed prior to hemming.

4. The method of claim 1, wherein the sleeve is formed by folding over the first end of said flag-length section.

5. The method of claim 1, wherein said sleeve is formed from a textile material that is separately attached to the first end of said flag-length section.

6. The method of claim 1, wherein said flag-length section has a second end opposite said first end, and said second end is hemmed prior to forming said sleeve.

7. The method of claim 1, wherein said indicia are printed on said sheet by sublimation printing.

8. The method of claim 1, wherein indicia are printed on the first and second sides of said sheet.

9. A method for making a printed flag comprising:
a) providing a continuous textile sheet having first and second side edges;
b) hemming the side edges of said sheet;
c) cutting said sheet into a plurality of flag-length sheet sections;
d) printing a plurality of indicia on at least one side of said sheet; and
e) forming a flagpole sleeve along said first end edge.

10. The method of claim 9, wherein said textile sheet is at least 50% polyester.

11. The method of claim 9, wherein said indicia are printed on said sheet by sublimation printing.

12. The method of claim 9, wherein said sections are rectangular sections having opposed parallel first and second end edges, said method including hemming said second end edge after printing of said indicia.

13. The method of claim 9, wherein said flagpole sleeve is formed by sewing said first end edge onto said section.

14. The method of claim 9, wherein said flagpole sleeve is formed by sewing a separate loop of textile material to said first end edge.

15. A method for making a printed flag comprising:
a) providing a continuous textile sheet having side edges and first and second sides;
b) printing a plurality of indicia along at least one side of said sheet;
d) cutting said sheet after printing into a plurality of flag-length sheet sections, each of said sections having one of said indicia on at least one side and a first end edge;
c) hemming the side edges of said sheet; and
e) forming a flagpole sleeve along said first end edge after said printing, cutting and hemming.

16. The method of claim 15, wherein said textile sheet is at least 50% polyester.

17. The method of claim 15, wherein said indicia are printed on said sheet by sublimation printing.

18. The method of claim 15, wherein said sections are rectangular sections having opposed parallel first and second end edges, said method including hemming said second end edge.

19. The method of claim 15, wherein said flagpole sleeve is formed by sewing said first end edge onto said section.

20. The method of claim 15, wherein said flagpole sleeve is formed by sewing a separate loop of textile material to said first end edge.

21. The method of claim 15, wherein indicia are printed on the first and second sides of said sheet.

22. A flag made in accordance with the method of claim 1.
